(19) United States
(12) Patent Application Publication
(10) Pub. No.: US 2018/0135920 A1
(43) Pub. Date: May 17, 2018

(54) HEAT EXCHANGER, INFORMATION PROCESSING DEVICE, AND FLAT TUBE MANUFACTURING METHOD

(71) Applicant: FUJITSU LIMITED, Kawasaki-shi (JP)

(72) Inventors: Yoshiteru OCHI, Hadano (JP); Hidehisa Sakai, Sagamihara (JP); Tsuyoshi So, Kawasaki (JP); Hideo Kubo, Kawasaki (JP)

(73) Assignee: FUJITSU LIMITED, Kawasaki-shi (JP)

(21) Appl. No.: 15/784,232

(22) Filed: Oct. 16, 2017

(30) Foreign Application Priority Data
Nov. 11, 2016 (JP) 2016-220376

(51) Int. Cl. F28F 1/04; F28D 7/00; F28D 1/053; F28F 9/00; G06F 9/50

(52) U.S. Cl. CPC F28F 1/045; F28D 7/0066; F28D 1/053; F28F 2215/02; G06F 9/5016; F28F 2225/08; F28F 9/001

(57) ABSTRACT

An electronic device includes a heat exchanger that includes a flat tube through which fluid flows. The flat tube includes a tube main body section, a connecting wall portion, and a flange portion. The tube main body section has a join portion at which an outer face at one end side of the tube main body section and an inner face at another end side of the tube main body section are joined together in an overlapping state to form a flat tube shape. The connecting wall portion extends from the one end of the tube main body section toward the inside of the tube main body section. The flange portion extends along the inner face of the tube main body section from a leading end part of the connecting wall portion toward an opposite side from the join portion, and is joined to the inner face.

This application is based upon and claims the benefit of priority of the prior Japanese Patent Application No. 2016-220376, filed on Nov. 11, 2016, the entire contents of which are incorporated herein by reference.

### FIELD

The embodiments discussed herein are related to a heat exchanger, an information processing device, and a flat tube manufacturing method.

### BACKGROUND

Existing radiators include a flat tube through which fluid flows (for example, see Japanese Laid-open Patent Publication No. 03-238165 and Japanese Laid-open Patent Publication No. 2011-089729).

For these kinds of flat tubes, one end of a sheet member and an outer face at another end of the sheet member are joined together in an overlapping state so as to form a flat cylinder shape. A connecting wall portion is also provided inside the flat tube. The connecting wall portion extends from the other end of the flat tube toward the inside of the flat tube and is joined to an inner face of the flat tube.

A single sheet member (metal sheet) may be processed to so as to form a flat tube having a flat tube shape.

### SUMMARY

According to an aspect of the embodiments, a heat exchanger includes a flat tube through which fluid flows. The flat tube includes a tube main body section, a connecting wall portion, and a flange portion. The tube main body section has a join portion at which an outer face at one end side of the tube main body section and an inner face at another end side of the tube main body section are joined together in an overlapping state to form a flat tube shape. The connecting wall portion extends from the one end of the tube main body section toward the inside of the tube main body section. The flange portion extends along the inner face of the tube main body section from a leading end part of the connecting wall portion toward an opposite side from the join portion, and is joined to the inner face.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a plan view illustrating an information processing device according to an exemplary embodiment;

FIG. 2 is a front face view of the radiator illustrated in FIG. 1;

FIG. 3 is an enlargement of a portion of FIG. 2, illustrating flat tubes and heat dissipating fins;

FIG. 4 is a cross-section taken along line 4-4 in FIG. 3;

FIG. 5 is an enlargement of a portion of FIG. 4, illustrating a flat tube;

FIG. 6 is an enlargement of a portion of FIG. 5, illustrating a connecting wall portion and a flange portion;

FIG. 7A is a cross-section of a sheet member serving as a base member for the flat tube illustrated in FIG. 5;

FIG. 7B is a cross-section of the sheet member illustrated in FIG. 7A, and illustrates the sheet member in a state formed with a connecting wall portion, a flange portion, and a step portion;

FIG. 7C is a cross-section of the sheet member illustrated in FIG. 7B, and illustrates the sheet member in a state having one side formed with a curved-face-forming portion;

FIG. 7D is a cross-section of the sheet member illustrated in FIG. 7C, and illustrates the sheet member in a state having another side formed with a curved-face-forming portion;

FIG. 8A is a cross-section of a sheet member serving as a base member of a flat tube according to a comparative example;

FIG. 8B is a cross-section of the sheet member illustrated in FIG. 8A, and illustrates the sheet member in a state formed with a connecting wall portion and a step portion;

FIG. 8C is a cross-section of the sheet member illustrated in FIG. 8B, and illustrates the sheet member in a state formed with a flange portion;

FIG. 8D is a cross-section of the sheet member illustrated in FIG. 8C, and illustrates the sheet member in a state having one side formed with a curved-face-forming portion;

FIG. 8E is a cross-section of the sheet member illustrated in FIG. 8D, and illustrates the sheet member in a state having another side formed with a curved-face-forming portion;

FIG. 9 is a cross-section corresponding to FIG. 5 illustrating a modified example of the flat tube according to an exemplary embodiment;

FIG. 10 is a cross-section corresponding to FIG. 5 illustrating a modified example of the flat tube according to an exemplary embodiment;

FIG. 11 is a cross-section corresponding to FIG. 5 illustrating a modified example of the flat tube according to an exemplary embodiment;

FIG. 12A is a cross-section of a sheet member serving as a base member for the flat tube illustrated in FIG. 11;

FIG. 12B is a cross-section of the sheet member illustrated in FIG. 12A, and illustrates the sheet member in a state formed with a connecting wall portion and a flange portion;

FIG. 12C is a cross-section of the sheet member illustrated in FIG. 12B, and illustrates the sheet member in a state formed with a connecting wall portion and a step portion;

FIG. 12D is a cross-section of the sheet member illustrated in FIG. 12C, and illustrates the sheet member in a state having one side formed with a curved-face-forming portion; FIG. 12E is a cross-section of the sheet member illustrated in FIG. 12D, and illustrates the sheet member in a state having another side formed with a curved-face-forming portion;

FIG. 13A is a cross-section illustrating a modified example of a heat dissipating fin according to an exemplary embodiment;

FIG. 13B is a cross-section illustrating a modified example of a heat dissipating fin according to an exemplary embodiment; and

FIG. 13C is a cross-section illustrating a modified example of a heat dissipating fin according to an exemplary embodiment.

### DESCRIPTION OF EMBODIMENTS

Explanation follows regarding an exemplary embodiment of technology disclosed herein.

### Information Processing Device

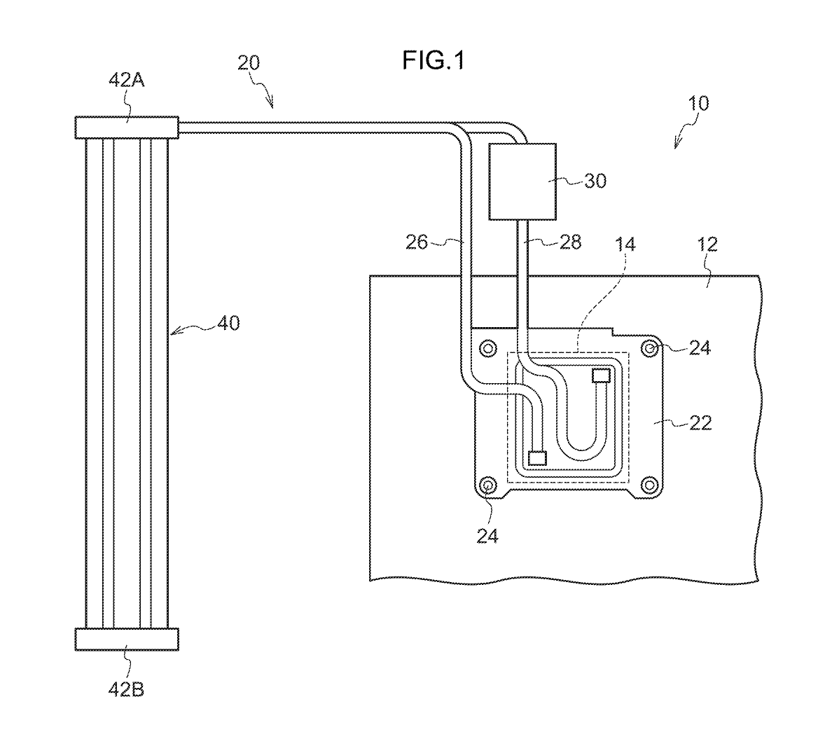

FIG. 1 illustrates an information processing device 10 according to the present exemplary embodiment. The information processing device 10 includes a printed substrate 12 and a cooling system 20. The printed substrate 12 is housed in a non-illustrated casing or the like. An electronic component 14 such as a central processing unit (CPU) or memory is mounted on the printed substrate 12. The electronic component 14 generates heat as power is consumed. The electronic component 14 is cooled by the cooling system 20.

### Cooling System, Cooling Module

The cooling system 20 includes a cooling module 22, a radiator 40, and a pump 30. The cooling module 22 is configured as a liquid-cooled heatsink in which a coolant such as water flows through the cooling module 22 to cool a cooling target. The cooling module 22 is fixed to the printed substrate 12 by, for example, screws 24 in a state in which the cooling module 22 has been installed over the electronic component 14. In this state, heat is exchanged between the coolant flowing through the cooling module 22 and the electronic component 14. The electronic component 14 is thereby cooled.

### Radiator

The radiator 40 is connected to the cooling module 22 through a coolant discharge tube 26 and a coolant supply tube 28. The radiator 40 releases heat (dissipates heat) from coolant discharged from the cooling module 22, thus configuring a heat exchanger that cools the coolant.

Coolant is discharged from the cooling module 22 to the radiator 40 through the coolant discharge tube 26. Coolant discharged to the radiator 40 from the cooling module 22 is supplied to the cooling module 22 through the coolant supply tube 28 after having been cooled by the radiator 40. Namely, the coolant discharge tube 26 and the coolant supply tube 28 form a circulating flow path that circulates coolant between the cooling module 22 and the radiator 40.

Note that the pump 30 is provided to the coolant supply tube 28. Coolant is supplied from the radiator 40 to the cooling module 22 using the pump 30.

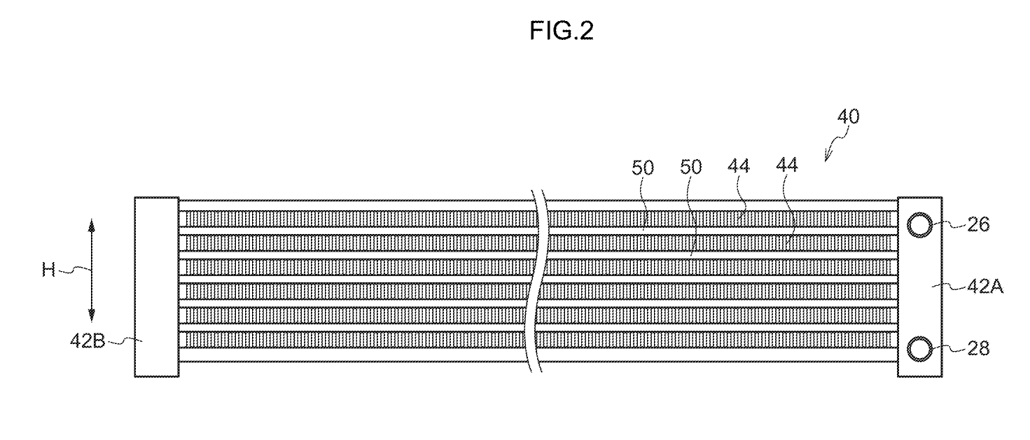

As illustrated in FIG. 2, the radiator 40 includes a pair of headers (header tanks) 42A, 42B; plural flat tubes 50; and plural heat dissipating fins 44. The pair of headers 42A, 42B form a flow path through which coolant flows.

Specifically, the pair of headers 42A, 42B are formed in a tube shape through which coolant flows. The pair of headers 42A, 42B are disposed along both sides of the radiator 40 running in the height direction (the arrow H direction) of the radiator 40. The above-described coolant discharge tube 26 is connected to an upper portion of the one header 42A out of the pair of headers 42A, 42B. The above-described coolant supply tube 28 is connected to a lower portion of the one header 42A.

Plural flat tubes (flattened tubes) 50 are formed into flat tube shapes through which coolant flows. The flat tubes 50 are disposed between the pair of headers 42A, 42B. The plural flat tubes 50 are disposed spaced apart in the height direction of the radiator 40. Note that coolant is one example of a fluid.

The plural flat tubes 50 connect the pair of headers 42A, 42B together. Coolant discharged from the coolant discharge tube 26 to the one header 42A thus travels back and forth between the pair of headers 42A, 42B through the plural flat tubes 50. The coolant is ultimately supplied from the coolant supply tube 28 connected to the one of the headers 42 to the cooling module 22 (see FIG. 1).

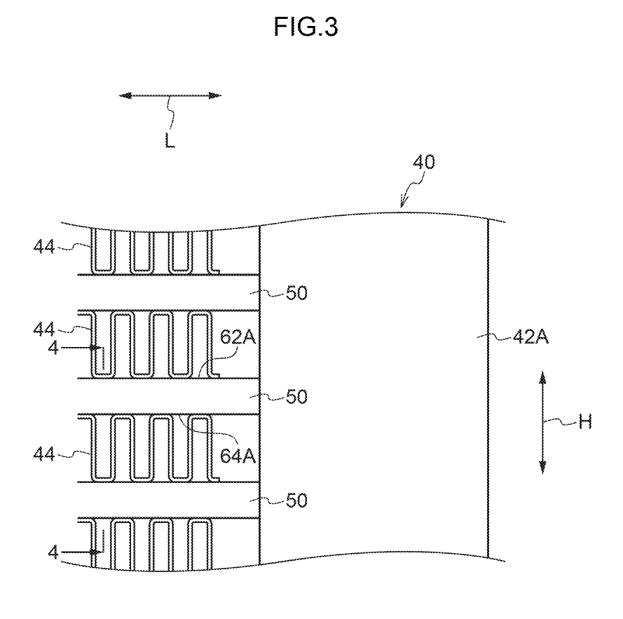

The plural heat dissipating fins 44 are heat dissipating members that release heat (dissipate heat) from coolant flowing through the flat tubes 50 into the atmosphere (air). Each heat dissipating fin 44 is, for example, formed from a metal sheet with high thermal conductivity, such as aluminum or copper. As illustrated in FIG. 3, the cross-section profile of the heat dissipating fins 44 is wave shaped so as to have an increased heat dissipating surface area.

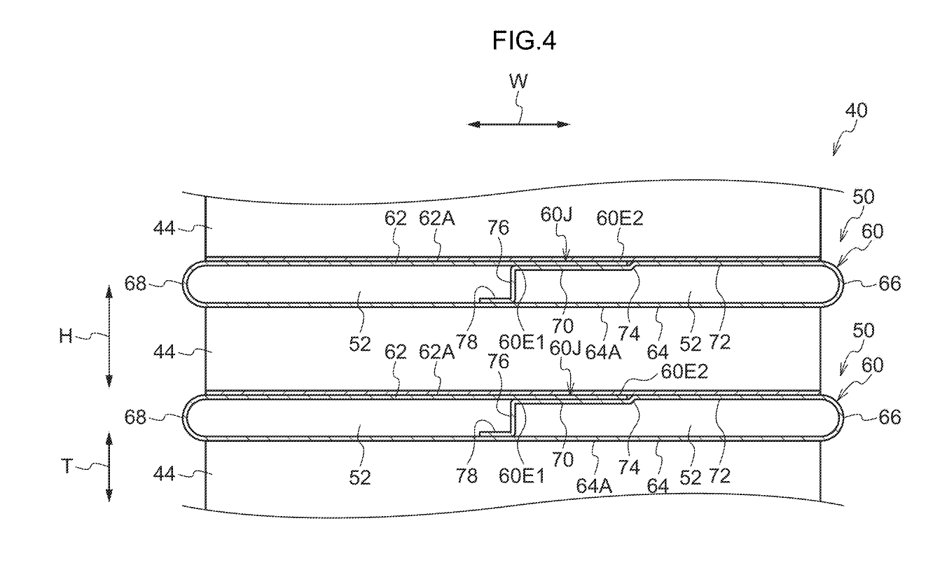

As illustrated in FIG. 3 and FIG. 4, the heat dissipating fins 44 and the flat tubes 50 are alternatingly disposed in the height direction of the radiator 40. Each of the heat dissipating fins 44 is brazed to the flat tubes 50 so as to enable heat exchange with the flat tubes 50. Heat from coolant flowing through the flat tubes 50 is thereby transmitted through the flat tubes 50 to the heat dissipating fins 44. The heat from the coolant that has been transmitted to the heat dissipating fins 44 is then released into the atmosphere. The coolant is thereby cooled.

Note that the heat dissipating fins 44 may be cooled using cooling air or the like generated by, for example, a fan.

### Flat Tubes

Detailed explanation follows regarding the configuration of the flat tubes 50.

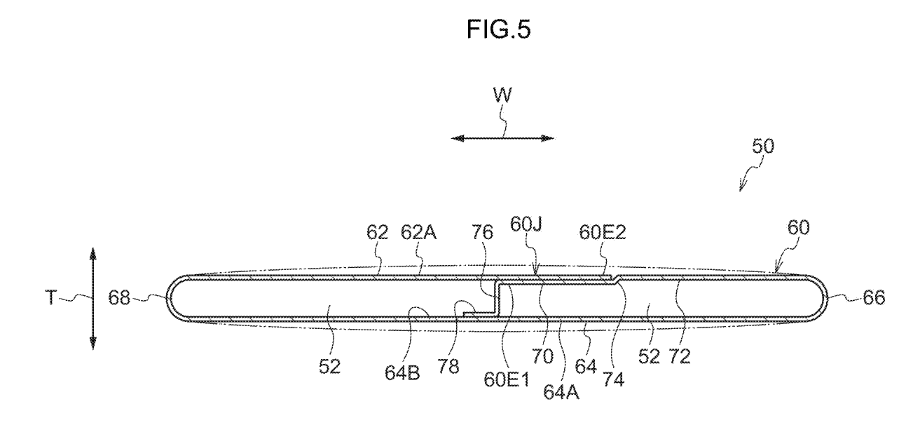

As illustrated in FIG. 5, each flat tube 50 is formed from a metal sheet with high thermal conductivity, such as aluminum or copper. Each flat tube 50 includes a tube main body section 60, a connecting wall portion 76, and a flange portion 78. Note that FIG. 5 illustrates a cross-section profile of the tube main body section 60 as viewed along its axial direction (the arrow L direction in FIG. 3).

### Tube Main Body Section

The tube main body section 60 is formed into a tube shape in which both axial direction ends of the tube main body section 60 are open. The tube main body section 60 includes one end 60E1 and another end 60E2 that extend along the axial direction of the tube main body section 60. The tube main body section 60 further includes a join portion 60J at which an inner face 60B at the other end 60E2 side and an outer face 70A (the outer face 70A of a flat-sheet-shaped join portion 70) at the one end 60E1 side are joined together in an overlapping state.

The one end 60E1 side and the other end 60E2 side of the tube main body section 60 are joined together in a state overlapping in the thickness direction of the tube main body section 60 (the arrow T direction). The tube main body section 60 thereby forms a flat tube shape. The tube main body section 60 is disposed such that the thickness direction of the tube main body section 60 is in the height direction of the radiator 40.

The tube main body section 60 includes a pair of a first flat-face-forming section 62 and a second flat-face-forming section 64 and a pair of curved-face-forming portions 66, 68. The pair of the first flat-face-forming section 62 and the second flat-face-forming section 64 is disposed on both sides in the thickness direction of the tube main body section 60. In addition, the pair of the first flat-face-forming section 62 and the second flat-face-forming section 64 face each other in the thickness direction of the tube main body section 60. The pair of the first flat-face-forming section 62 and the second flat-face-forming section 64 are formed in flat sheet shapes running along the width direction (the arrow W direction) of the tube main body section 60.

Outer faces 62A, 64A of the pair of the first flat-face-forming section 62 and the second flat-face-forming section 64 configure flat faces (flat surfaces). As illustrated in FIG. 4, respective heat dissipating fins 44 are brazed to the outer faces 62A, 64A of the first flat-face-forming section 62 and the second flat-face-forming section 64. The heat dissipating fins 44 are provided spanning from one width direction end side to the other width direction end side of the first flat-face-forming section 62 and the second flat-face-forming section 64.

As illustrated in FIG. 5, the pair of the curved-face-forming portions 66, 68 are disposed at both width direction sides of the tube main body section 60. The pair of curved-face-forming portions 66, 68 face each other in the width direction of the tube main body section 60. Further, the pair of the curved-face-forming portions 66, 68 are bent so as to be respectively convex on the side away from each other. The outer faces of the pair of curved-face-forming portions 66, 68 configure curving bend faces.

The one curved-face-forming portion 66 out of the pair of curved-face-forming portions 66, 68 connects together portions at one width direction end of the pair of the first flat-face-forming section 62 and the second flat-face-forming section 64. The other curved-face-forming portion 68 out of the pair of curved-face-forming portions 66, 68 connects together portions at the other width direction end of the pair of the first flat-face-forming section 62 and the second flat-face-forming section 64.

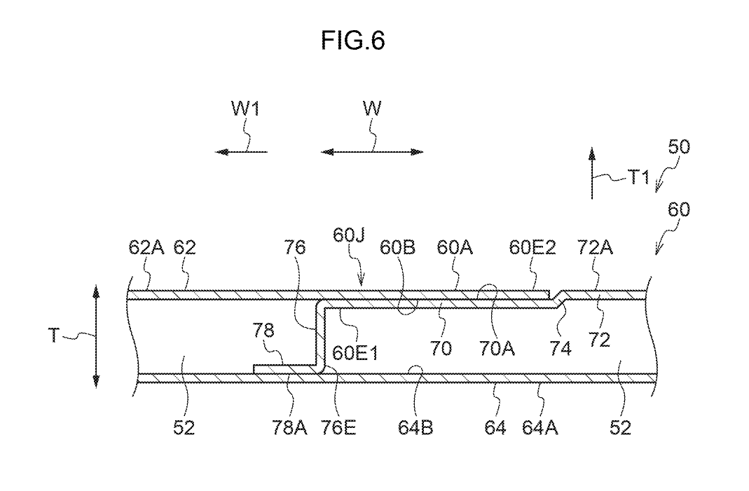

As illustrated in FIG. 6, the first flat-face-forming section 62 includes the above-described join portion 60J. The join portion 60J is provided at a width direction central portion of the first flat-face-forming section 62. Namely, the inner face 60B at the other end 60E2 side of the tube main body section 60 and the outer face 70A at the one end 60E1 side of the tube main body section 60 are joined together in an overlapping state at a width direction central portion of the first flat-face-forming section 62. The flat-sheet-shaped join portion 70 and an outside flat-sheet-shaped portion 72 are provided at the one end 60E1 side of the tube main body section 60.

The flat-sheet-shaped join portion 70 is formed in a flat sheet shape running along the width direction of the tube main body section 60. The inner face 60B at the other end 60E2 side of the tube main body section 60 is joined to the outer face 70A of the flat-sheet-shaped join portion 70 in an overlapping state using brazing.

The outside flat-sheet-shaped portion 72 is formed in a flat sheet shape running along the width direction of the tube main body section 60. The outside flat-sheet-shaped portion 72 is disposed at the opposite side (the opposite side to the arrow W1) from the connecting wall portion 76 described below. The outside flat-sheet-shaped portion 72 is disposed at the thickness direction outer side (the arrow T1 side) of the tube main body section 60 with respect to the flat-sheet-shaped join portion 70.

A step portion 74 is provided between the flat-sheet-shaped join portion 70 and the outside flat-sheet-shaped portion 72. The step portion 74 connects adjacent end portions of the outside flat-sheet-shaped portion 72 and the flat-sheet-shaped join portion 70 together. The step portion 74 forms a step between the outside flat-sheet-shaped portion 72 and the flat-sheet-shaped join portion 70. Thus, an outer face 60A at the other end 60E2 side of the tube main body section 60 and an outer face 72A of the outside flat-sheet-shaped portion 72 are flush with each other. In other words, the outer face 60A at the other end 60E2 side of the tube main body section 60 and the outer face 72A of the outside flat-sheet-shaped portion 72 are disposed in the same plane.

Note that herein, “flush” is not limited to cases in which the outer face 60A at the other end 60E2 side of the tube main body section 60 and the outer face 72A of the outside flat-sheet-shaped portion 72 are strictly disposed in the same plane. Herein, “flush” encompasses cases in which a slight step or the like is formed between the outer face 60A at the other end 60E2 side of the tube main body section 60 and the outer face 72A of the outside flat-sheet-shaped portion 72 due to, for example, errors in processing the tube main body section 60.

### Connecting Wall Portion

The connecting wall portion 76 is provided at the one end 60E1 of the tube main body section 60. The connecting wall portion 76 is provided along the one end 60E1 of the tube main body section 60. The connecting wall portion 76 extends along the thickness direction of the tube main body section 60 from the one end 60E1 of the tube main body section 60 toward the inside of the tube main body section 60 (flow path 52). Namely, the connecting wall portion 76 extends from the first flat-face-forming section 62 toward the second flat-face-forming section 64 side.

A extension direction (a direction opposite to the arrow T1) leading end part 76E of the connecting wall portion 76 contacts an inner face 64B of the second flat-face-forming section 64. Namely, the connecting wall portion 76 is disposed spanning between the first flat-face-forming section 62 and the second flat-face-forming section 64. The flange portion 78 is provided to the leading end part 76E of the connecting wall portion 76.

### Flange Portion

The flange portion 78 extends along the inner face 64B of the second flat-face-forming section 64 from the leading end part 76E of the connecting wall portion 76 toward the opposite side (the arrow W1 side) from the join portion 60J. The flange portion 78 is formed in a flat sheet shape running along the width direction of the tube main body section 60. The flange portion 78 is provided running along the leading end part 76E of the connecting wall portion 76.

An outer face 78A of the flange portion 78 and the inner face 64B of the second flat-face-forming section 64 are joined together using brazing. The connecting wall portion 76 is thereby fixed to the second flat-face-forming section 64. The connecting wall portion 76 connects (couples) the first flat-face-forming section 62 and the second flat-face-forming section 64 together.

### Method of Manufacturing Flat Tube

Explanation follows regarding a method of manufacturing the flat tubes 50.

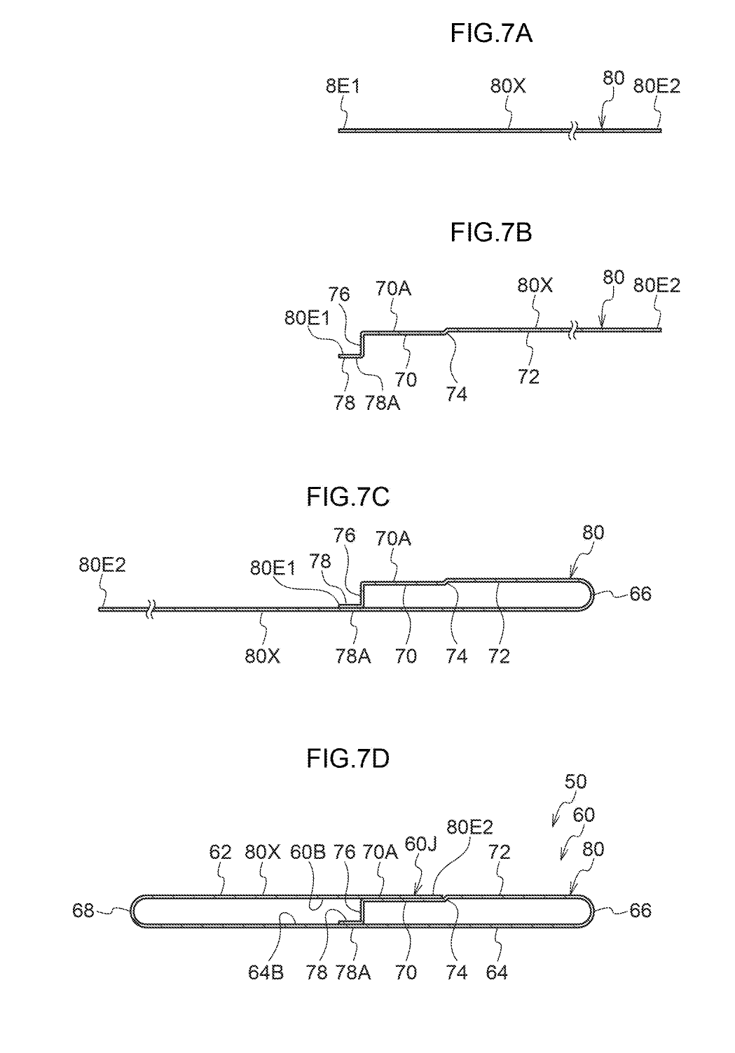

FIG. 7A illustrates a flat-sheet-shaped sheet member 80 serving as a base member for a flat tube 50. Both faces of the sheet member 80 are pre-applied (clad) with a brazing filler (flux). The sheet member 80 is sequentially conveyed to a pressing processing device and a rolling processing device, not illustrated, and is respectively processed by the pressing processing device and the rolling processing device. Then, the sheet member 80 is conveyed to a heating device such as a furnace for brazing. The flat tube 50 is thereby formed.

Specifically, first, as illustrated in FIG. 7B, in a pressing procedure, one end 80E1 side of the sheet member 80 is folded into a crank shape in a pressing process. The step portion 74 is formed in a sheet member main body portion 80X of the sheet member 80 in the same pressing process. The connecting wall portion 76, which is bent at a right angle with respect to the sheet member main body portion 80X, and the flange portion 78, which is bent at a right angle with respect to the connecting wall portion 76 towards the opposite side from the sheet member main body portion 80X, are thereby formed at the one end 80E1 side of the sheet member 80. Further, the flat-sheet-shaped join portion 70 and the outside flat-sheet-shaped portion 72 are formed to the sheet member main body portion 80X.

Note that the flat-sheet-shaped join portion 70 and the outside flat-sheet-shaped portion 72 are an example of a flat-sheet-shaped section. Also note that the flat-sheet-shaped join portion 70 is an example of a region of the flat-sheet-shaped section further toward the connecting wall portion 76 side than the step portion 74.

Next, as illustrated in FIG. 7C, in a first bending procedure, while leaving the flat-sheet-shaped join portion 70 and the outside flat-sheet-shaped portion 72 in the sheet member main body portion 80X, the sheet member main body portion 80X is bent around in a U-shape toward the flange portion 78 side in a bending process so as to form the curved-face-forming portion 66. Thus, the sheet member main body portion 80X, which has been folded back toward the flange portion 78 side, is disposed along the outer face 78A of the flange portion 78.

Next, as illustrated in FIG. 7D, in a second bending procedure, at another end 80E2 side of the sheet member 80 beyond the flange portion 78, the sheet member main body portion 80X is bent around in a U-shape toward the flat-sheet-shaped join portion 70 side in a bending process so as to form the curved-face-forming portion 68. Thus, the other end side of the sheet member main body portion 80X, which has been folded back toward the flat-sheet-shaped join portion 70 side, namely the other end 80E2 side of the sheet member 80, is disposed along the outer face 70A of the flat-sheet-shaped join portion 70. The sheet member 80 is thereby formed into a flat tube shape.

Next, the sheet member 80 formed into a flat tube shape is conveyed to a heating device such as a furnace. Thereby, the brazing filler applied to the sheet member 80 is heated, the inner face 60B (also see FIG. 6) at the other end 80E2 side of the sheet member 80 is brazed to the outer face 70A of the flat-sheet-shaped join portion 70, and the outer face 78A of the flange portion 78 is brazed to the inner face 64B of the sheet member main body portion 80X (the second flat-face-forming section 64). This results in the formation of the tube main body section 60 and the flat tube 50.

### Operation and Advantageous Effects

Explanation follows regarding the operation and advantageous effects of the present exemplary embodiment.

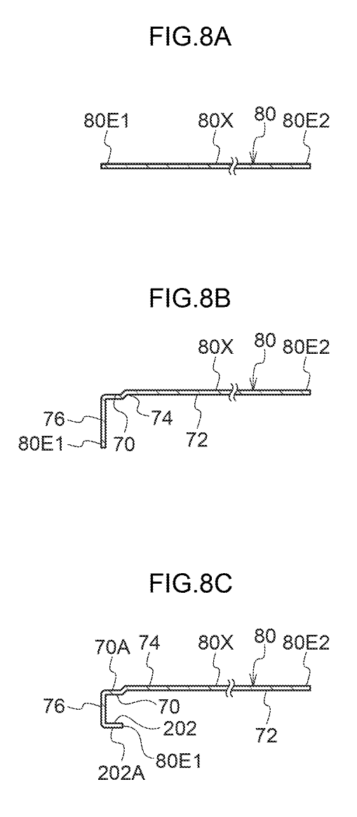

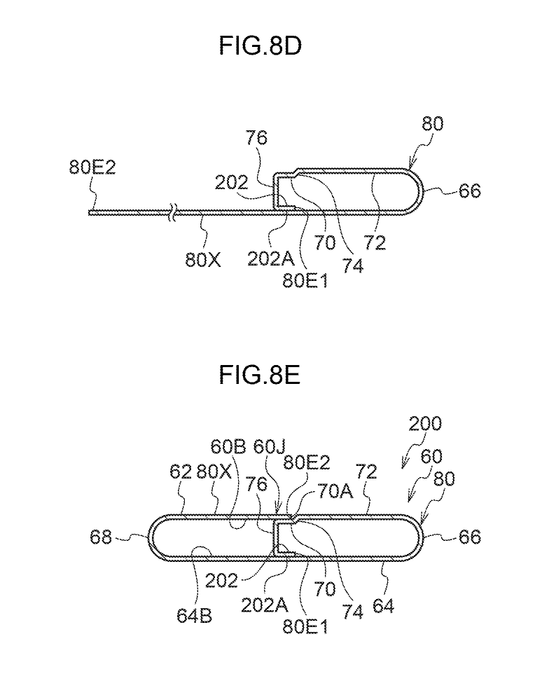

Explanation is first given of a method of manufacturing a flat tube 200 according to a comparative example. FIG. 8E illustrates a flat tube 200 according to the comparative example. In the flat tube 200, a flange portion 202 extends along an inner face 64B of a second flat-face-forming section 64 from a leading end part 76E of a connecting wall portion 76 toward a curved-face-forming portion side. The flat tube 200 according to the comparative example is, for example, manufactured as follows.

Namely, FIG. 8A illustrates a sheet member 80 serving as a base member for the flat tube 200. From this state, first, as illustrated in FIG. 8B, the connecting wall portion 76, a flat-sheet-shaped join portion 70, and an outside flat-sheet-shaped portion 72 are formed at one end 80E1 side of the sheet member 80 in a pressing process.

Next, as illustrated in FIG. 8C, a leading end side of the connecting wall portion 76 is bent toward the flat-sheet-shaped join portion 70 side in a bending process.

Next, as illustrated in FIG. 8D, while leaving the flat-sheet-shaped join portion 70 and the outside flat-sheet-shaped portion 72 in the sheet member main body portion 80X, the sheet member main body portion 80X is bent around in a U-shape toward the flange portion 202 side in a bending process so as to form a curved-face-forming portion 66. Thus, the sheet member main body portion 80X, which has been folded back toward the flange portion 202 side, is disposed along an outer face 202A of the flange portion 202.

Next, as illustrated in FIG. 8E, at another end 80E2 side of the sheet member 80 beyond the flange portion 202, the sheet member main body portion 80X is bent around in a U-shape toward the flat-sheet-shaped join portion 70 side in a bending process so as to form a curved-face-forming portion 68. Thus, the other end side of the sheet member main body portion 80X, which has been folded back toward the flat-sheet-shaped join portion 70 side, namely the other end 80E2 side of the sheet member 80, is disposed along an outer face 70A of the flat-sheet-shaped join portion 70. The sheet member 80 is thereby formed into a flat tube shape.

Next, the sheet member 80 formed into a flat tube shape is conveyed to a heating device such as a furnace. Thereby, brazing filler applied to the sheet member 80 is heated, an inner face 60B (also see FIG. 6) at the other end 80E2 side of the sheet member 80 is brazed to the outer face 70A of the flat-sheet-shaped join portion 70, and the outer face 202A of the flange portion 202 is brazed to an inner face 64B of the sheet member main body portion 80X (the second flat-face-forming section 64). This results in the formation of the tube main body section 60 and the flat tube 200.

In the flat tube 200 according to the comparative example, the connecting wall portion 76 and the flange portion 202 are thus formed in separate procedures.

In addition, in cases in which a connecting wall portion is provided inside the flat tube, the number of procedures performed on the sheet member is increased, and the manufacturability of the flat tube may be reduced.

In contrast thereto, in the flat tube 50 according to the present exemplary embodiment, the connecting wall portion 76 and the flange portion 78 are formed in the same procedure (pressing procedure). Thus, there are fewer procedures performed on a sheet member 80 for the flat tube 50 according to the present exemplary embodiment than for the flat tube 200 according to the comparative example. Accordingly, in the present exemplary embodiment, the manufacturability of the flat tube 50 is increased.

Namely, one aspect of technology disclosed herein enables the manufacturability of a flat tube to be increased.

Moreover, in the flat tube 50 according to the present exemplary embodiment, the first flat-face-forming section 62 and the second flat-face-forming section 64 are connected together through the connecting wall portion 76 and the flange portion 78. Note that as illustrated in FIG. 5, when coolant flows through the flow path 52 in the flat tube 50, pressure in the flow path 52 rises.

Thus, it is possible that the flat tube 50 will expand in the thickness direction such as illustrated by the double-dotted dashed line in FIG. 5. When the flat tube 50 expands in the thickness direction, the first flat-face-forming section 62 and the outer face 64A of the second flat-face-forming section 64 bend such that the heat dissipating fins 44 (see FIG. 4) are liable to separate from the first flat-face-forming section 62 and the outer face 64A of the second flat-face-forming section 64. When the heat dissipating fins 44 separate from the first flat-face-forming section 62 and the outer face 64A of the second flat-face-forming section 64, the efficiency of heat transfer from the flat tube 50 to the heat dissipating fins 44 is reduced, and the cooling ability of the coolant may be reduced.

In contrast thereto, in the present exemplary embodiment, the first flat-face-forming section 62 and the second flat-face-forming section 64 are connected together through the connecting wall portion 76 and the flange portion 78. Thus, even if the pressure in the flow path 52 of the flat tube 50 rises, expansion of the flat tube 50 in the thickness direction is suppressed. As a result, separation of the heat dissipating fins 44 (see FIG. 4) from the first flat-face-forming section 62 and the outer face 64A of the second flat-face-forming section 64 is suppressed. Accordingly, reduction of the cooling ability of the coolant is suppressed.

### Modified Examples

Explanation follows regarding modified examples of the above exemplary embodiment.

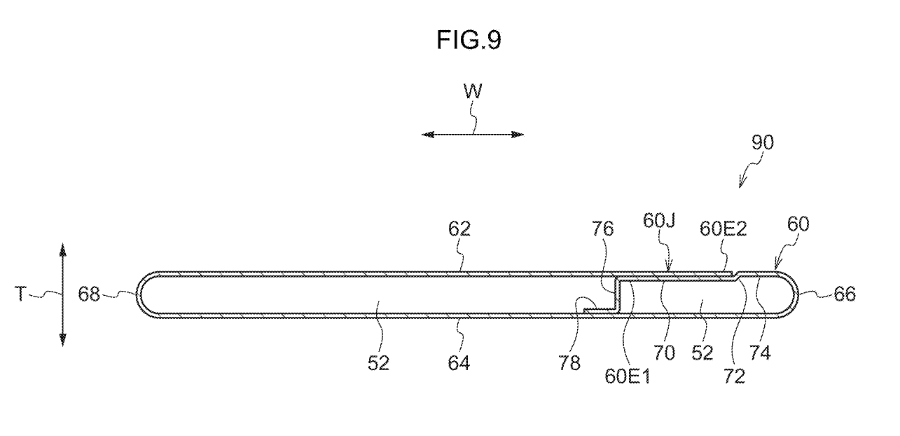

In the above exemplary embodiment, the connecting wall portion 76 is disposed at the width direction central portion of the flat tube 50. However, as in the flat tube 90 illustrated in FIG. 9, for example, the connecting wall portion 76 may be disposed at one width direction side (the curved-face-forming portion 66 side) of the flat tube 50.

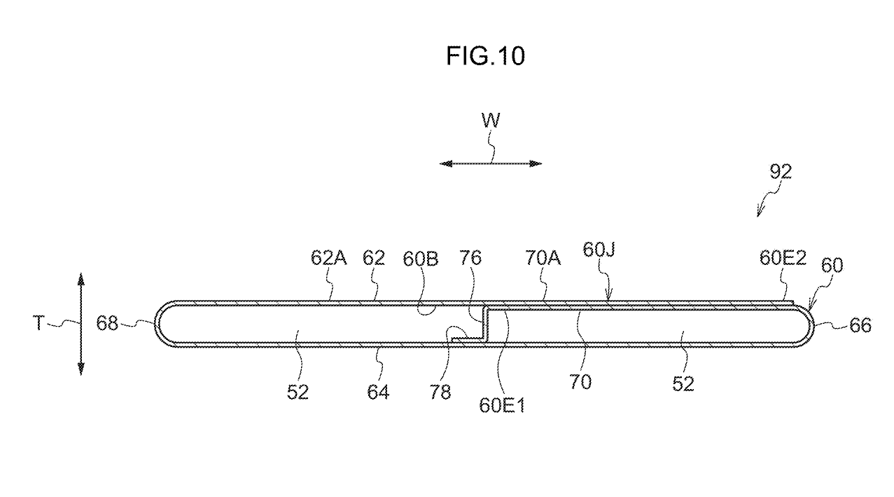

In the above exemplary embodiment, the flat tube 50 is also provided with the step portion 74 and the outside flat-sheet-shaped portion 72. However, as in the flat tube 92 illustrated in FIG. 10, for example, the step portion 74 and the outside flat-sheet-shaped portion 72 may be omitted.

Note that in a method for manufacturing the flat tube 92, for example, in the pressing procedure illustrated in FIG. 7B, the one end 80E1 side of the sheet member 80 is folded into a crank shape in a pressing process without forming the step portion 74 in the sheet member main body portion 80X of the sheet member 80. Subsequent manufacturing procedures for the flat tube 92 are the same as manufacturing procedures for the flat tube 50.

In addition, in the flat tube 92 illustrated in FIG. 10, the flat-sheet-shaped join portion 70 is provided spanning between the one end 60E1 of the tube main body section 60 and the one curved-face-forming portion 66. The inner face 60B at the other end 60E2 side of the tube main body section 60 and the outer face 70A of the flat-sheet-shaped join portion 70 are joined together in an overlapping state. The first flat-face-forming section 62 is thereby formed.

In addition, the other end 60E2 of the tube main body section 60 reaches to the end portion on the one curved-face-forming portion 66 side of the flat-sheet-shaped join portion 70. There is therefore no step in the outer face 62A of the first flat-face-forming section 62. Accordingly, it is easier to join the heat dissipating fins 44 (see FIG. 4) to the outer faces 62A of the first flat-face-forming section 62.

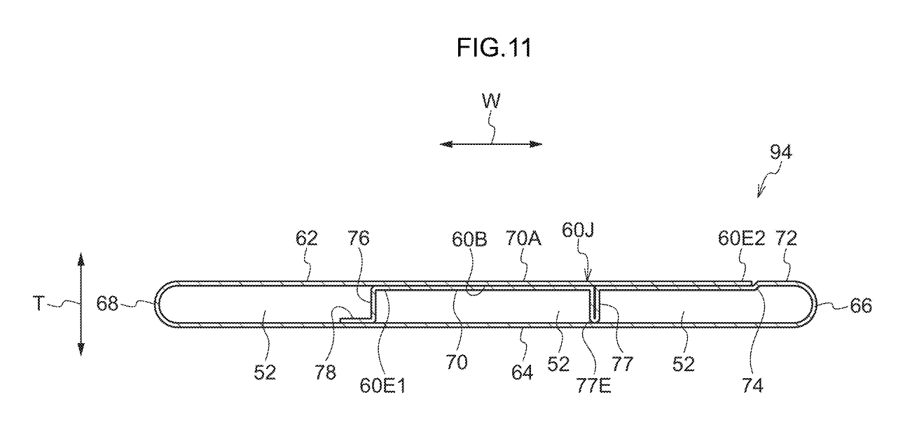

Further, for example, as illustrated in FIG. 11, a flat tube 94 may be provided with plural connecting wall portions 76, 77. In such cases, expansion of the flat tube 94 in the thickness direction is even further suppressed.

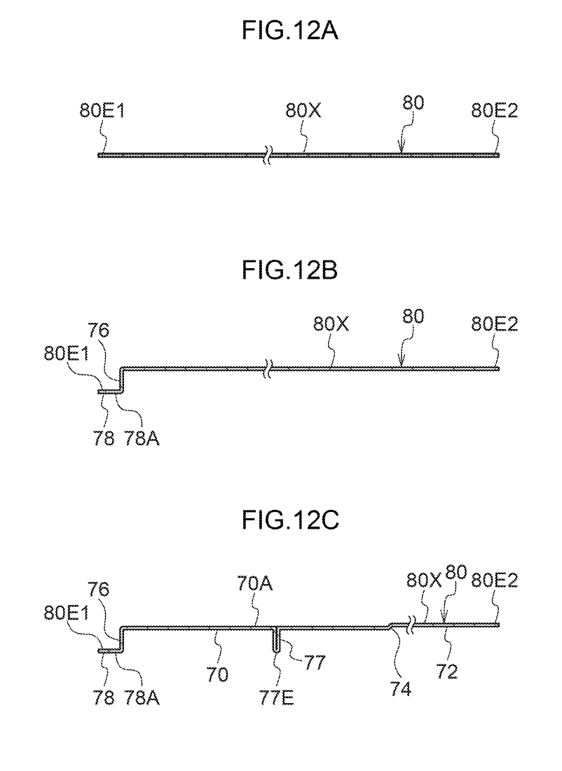

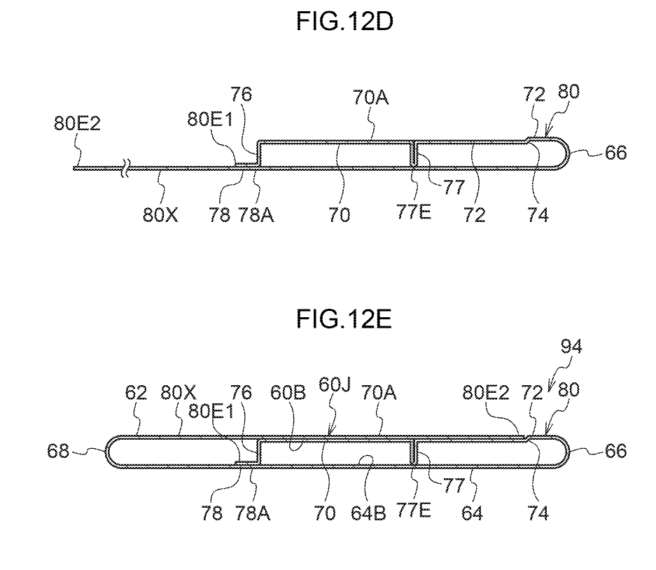

Explanation follows regarding a method of manufacturing the flat tube 94. FIG. 12A illustrates a sheet member 80 serving as a base member for the flat tube 94. From this state, first, as illustrated in FIG. 12B, in a pressing procedure, one end 80E1 side of the sheet member 80 is folded into a crank shape in a pressing process. A connecting wall portion 76, which is bent at a right angle with respect to a sheet member main body portion 80X, and a flange portion 78, which is bent at a right angle with respect to the connecting wall portion 76 towards the opposite side from the sheet member main body portion 80X, are thereby formed at the one end 80E1 side of the sheet member 80.

Next, as illustrated in FIG. 12C, in a connecting wall portion forming procedure, a connecting wall portion 77 is formed in the sheet member main body portion 80X in a bending process. Then, in a step portion forming procedure, a step portion 74 is formed in the sheet member main body portion 80X in a pressing process. A flat-sheet-shaped join portion 70 and an outside flat-sheet-shaped portion 72 are thereby formed in the sheet member main body portion 80X.

Next, as illustrated in FIG. 12D, in a first bending procedure, while leaving the flat-sheet-shaped join portion 70 and the outside flat-sheet-shaped portion 72 in the sheet member main body portion 80X, the sheet member main body portion 80X is bent around in a U-shape toward the flange portion 78 side in a bending process so as to form a curved-face-forming portion 66. Thus, the sheet member main body portion 80X, which has been folded back toward the flange portion 78 side, is disposed along a leading end 77E of the connecting wall portion 77 and an outer face 78A of the flange portion 78.

Next, as illustrated in FIG. 12E, in a second bending procedure, at another end 80E2 side of the sheet member 80 beyond the flange portion 78, the sheet member main body portion 80X is bent around in a U-shape toward the flat-sheet-shaped join portion 70 side in a bending process so as to form a curved-face-forming portion 68. Thus, the other end side of the sheet member main body portion 80X, which has been folded back toward the flat-sheet-shaped join portion 70 side, namely toward the other end 80E2 side of the sheet member 80, is disposed along an outer face 70A of the flat-sheet-shaped join portion 70. The sheet member 80 is thereby formed into a flat tube shape.

Next, the sheet member 80 formed into a flat tube shape is conveyed to a heating device such as a furnace. Thereby, the brazing filler applied to the sheet member 80 is heated, and an inner face 60B (also see FIG. 6) at the other end 80E2 side of the sheet member 80 is brazed to the outer face 70A of the flat-sheet-shaped join portion 70. An outer face 78A of the flange portion 78 and the leading end 77E of the connecting wall portion 77 are also brazed to an inner face 64B of the sheet member main body portion 80X (second flat-face-forming section 64). This results in the formation of the tube main body section 60 and the flat tube 94.

In the above exemplary embodiments, the connecting wall portion 76 is disposed along the thickness direction (arrow T direction) of the tube main body section 60. However, the connecting wall portion 76 may, for example, be inclined with respect to the thickness direction of the tube main body section 60.

Further, in the above exemplary embodiments, a join portion 60J is provided to the first flat-face-forming section 62. However, the join portion 60J may be provided to the second flat-face-forming section 64.

Further, in the above exemplary embodiments, the outer face 70A of the flat-sheet-shaped join portion 70 and the inner face 60B at the other end 60E2 side of the tube main body section 60 are brazed together. However, the outer face 70A of the flat-sheet-shaped join portion 70 and the inner face 60B at the other end 60E2 side of the tube main body section 60 may be joined together by welding, adhesion, or the like.

Similarly, in the above exemplary embodiments, the outer face 78A of the flange portion 78 and the inner face 64B of the second flat-face-forming section 64 are brazed together. However, the outer face 78A of the flange portion 78 and the inner face 64B of the second flat-face-forming section 64 may be joined together by welding, adhesion, or the like.

Further, in the above exemplary embodiments, flat tubes 50 are applied to the radiator 40. However, the flat tubes 50 may be suitably applied to a heat exchanger other than the radiator 40.

Explanation follows regarding modified examples of the heat dissipating members (heat dissipating fins).

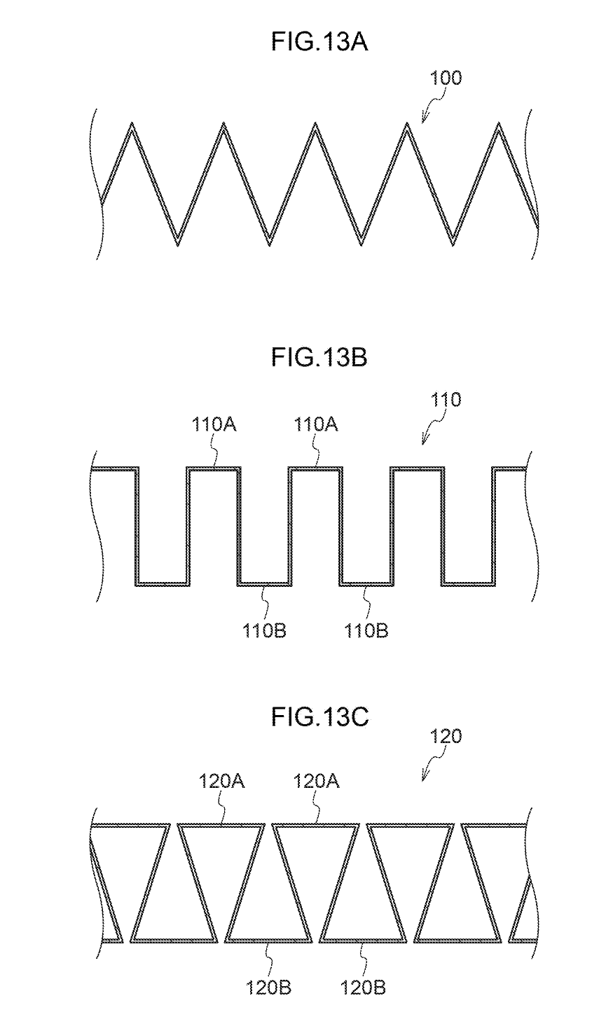

As illustrated in FIG. 13A, the cross-section profile of a heat dissipating fin 100 may have a wave shaped fold line profile.

Further, as illustrated in FIG. 13B, a heat dissipating fin 110 may include first U-shaped portions 110A and second U-shaped portions 110B that are alternatingly disposed in a state pointing in mutually opposite directions in cross-section view.

Further, as illustrated in FIG. 13C, a heat dissipating fin 120 may include plural first triangular portions 120A and second triangular portions 120B that are alternately disposed in a state pointing in mutually opposing directions in cross-section view.

Note that the heat dissipating fins 100, 110, and 120 described above are formed from a single sheet member configured by a metal sheet or the like. Moreover, the heat dissipating fins 100, 110, and 120 are examples of a heat dissipating member.

Note that the contact surface area with air can be more easily increased with the heat dissipating fin 100 illustrated in FIG. 13A than with the heat dissipating fin 110 illustrated in FIG. 13B. It is therefore easier to increase the heat dissipation efficiency in the heat dissipating fin 100 than in the heat dissipating fin 110.

However, the contact surface area with the flat tube 50 is greater in the heat dissipating fin 110 than in the heat dissipating fin 100, and so the strength of the heat dissipating fin 110 is higher than that of the heat dissipating fin 100. Accordingly, the heat dissipating fin 110 is less liable than the heat dissipating fin 100 to deform when the flat tube 50 has expanded in the thickness direction.

Further, similarly to the heat dissipating fin 100, the contact surface area with air can be easily increased with the heat dissipating fin 120 illustrated in FIG. 13C. Moreover, similarly to the heat dissipating fin 110, the contact surface area with the flat tube 50 can be easily increased with the heat dissipating fin 120. Accordingly, while increasing heat dissipation efficiency, the heat dissipating fin 120 enables deformation of the heat dissipating fin 120 to be suppressed when the flat tube 50 has expanded in the thickness direction.

Explanation has been given regarding exemplary embodiments of technology disclosed herein. However, the technology disclosed herein is not limited to the exemplary embodiments described above. The exemplary embodiments described above may be employed in any suitable combination with the various modified examples, and obviously various configurations may be implemented within a range not departing from the spirit of the technology disclosed herein.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A heat exchanger, comprising:
a flat tube through which fluid flows, the flat tube including:
a tube main body section having a join portion at which an outer face at one end side of the tube main body section and an inner face at another end side of the tube main body section are joined together in an overlapping state to form a flat tube shape,
a connecting wall portion that extends from the one end of the tube main body section toward the inside of the tube main body section, and
a flange portion that extends along the inner face of the tube main body section from a leading end part of the connecting wall portion toward an opposite side from the join portion, and that is joined to the inner face.

2. The heat exchanger of claim 1, wherein the flat tube is formed from a single sheet member.

3. The heat exchanger of claim 1, wherein the tube main body section includes a flat-sheet-shaped join portion that is disposed at one side in a thickness direction of the tube main body section and that is joined to the other end side of the tube main body section in an overlapping state.

4. The heat exchanger of claim 3, wherein the tube main body section includes an outside flat-sheet-shaped portion that is disposed at the opposite side of the flat-sheet-shaped join portion from the connecting wall portion and that is disposed at a thickness direction outer side of the flat-sheet-shaped join portion such that a step is formed between the flat-sheet-shaped join portion and the outside flat-sheet-shaped portion.

5. The heat exchanger of claim 4, wherein the tube main body section includes a step portion that connects the flat-sheet-shaped join portion to the outside flat-sheet-shaped portion.

6. The heat exchanger of claim 4, wherein an outer face at the other end side of the tube main body section and an outer face of the outside flat-sheet-shaped portion are flush with each other.

7. The heat exchanger of claim 4, further comprising a heat dissipating member that is disposed so as to extend from the outer face at the other end side of the tube main body section to an outer face of the outside flat-sheet-shaped portion, and is configured to exchange heat with the tube main body section.

8. The heat exchanger of claim 1, further comprising a heat dissipating member that is disposed at one side in a thickness direction of the tube main body section, and is configured to exchange heat with the tube main body section.

9. The heat exchanger of claim 8, wherein the heat dissipating member includes a plurality of first triangular portions and second triangular portions that are alternately disposed in a state pointing in mutually opposing directions in cross-section view.

10. The heat exchanger of claim 9, wherein the first triangular portions and the second triangular portions are formed from a single sheet member.

11. The heat exchanger of claim 8, wherein the heat dissipating member includes a wave-shaped heat dissipating fin.

12. The heat exchanger of claim 1, wherein the one end side and the other end side of the tube main body section are joined together in a state overlapping in a thickness direction of the tube main body section.

13. The heat exchanger of claim 1, wherein:
the tube main body section includes a first flat-face-forming section and a second flat-face-forming section that face each other in a thickness direction of the tube main body section;
the connecting wall portion extends from the first flat-face-forming section toward the second flat-face-forming section side; and
the flange portion is joined to an inner face of the second flat-face-forming section.

14. The heat exchanger of claim 1, wherein the connecting wall portion is disposed along a thickness direction of the tube main body section.

15. The heat exchanger of claim 1, wherein:
the outer face at the one end side of the tube main body section and the inner face at the other end side of the tube main body section are brazed together; and
the flange portion and the inner face of the tube main body section are brazed together.

16. The heat exchanger of claim 1, wherein the connecting wall portion is disposed at a width direction central portion of the tube main body section.

17. An information processing device, comprising:
an electronic component; and
a heat exchanger that includes a flat tube through which fluid flows, the heat exchanger being configured to cool the fluid, which cools the electronic component, the flat tube including:
a tube main body section having a join portion at which an outer face at one end side of the tube main body section and an inner face at another end side of the tube main body section are joined together in an overlapping state to form a flat tube shape,
a connecting wall portion that extends from the one end of the tube main body section toward the inside of the tube main body section, and
a flange portion that extends along the inner face of the tube main body section from a leading end part of the connecting wall portion toward an opposite side from the join portion, and that is joined to the inner face.

18. A method of manufacturing a flat tube, the method comprising:
folding one end side of a sheet member into a crank shape in a pressing process so as to form a connecting wall portion that is bent with respect to a sheet member main body portion of the sheet member and a flange portion that is bent with respect to the connecting wall portion;
bending the sheet member main body portion around in a U-shape toward the flange portion side while leaving a flat-sheet-shaped section in the sheet member main body portion, so as to dispose the folded-back sheet member main body portion along an outer face of the flange portion; and
at another end side of the sheet member beyond the flange portion, bending the sheet member main body portion around in a U-shape toward the flat-sheet-shaped section side so as to dispose the folded-back sheet member main body portion along an outer face of the flat-sheet-shaped section.

19. The flat tube manufacturing method of claim 18, further comprising forming a step portion in the flat-sheet-shaped section in the pressing process and positioning, toward the flange portion side of the flat-sheet-shaped section, a region of the flat-sheet-shaped section that is further toward the connecting wall portion side than the step portion, and disposing the sheet member main body portion along an outer face of the region.

20. The flat tube manufacturing method of claim 18, further comprising heating brazing filler applied to the sheet member, brazing the sheet member main body portion and the flat-sheet-shaped section together, and brazing the sheet member main body portion and the flange portion together.
